(19) United States
(12) Patent Application Publication
(10) Pub. No.: US 2004/0011830 A1
(43) Pub. Date: Jan. 22, 2004

(54) Dosing dispenser including multifunction cap

(76) Inventor: Su Heon Kim, Palatine, IL (US)

Correspondence Address: Pyle & Piontek, Suite 850, 221 N. LaSalle Street, Chicago, IL, 60601, US

(21) Appl. No.: 10/197,162

(22) Filed: Jul. 17, 2002

(51) Int. Cl. B67D 3/00

(52) U.S. Cl. 222/559

(57) ABSTRACT

The dosing dispenser may have a body having a discharge path therein, the discharge path having an outlet and having a check valve, flow throttling structure, and on/off control therein for assuring against leakage of liquid or vapors from the dispenser when said on/off control is in the off position. The throttling structure allows for desired dosing of liquid from the outlet with the check valve acting to control escape of vapors or fumes from the liquid therein when the on/off control is in the on position. Also a spillage trap maybe provided to catch any drips from the outlet. The dispenser may bear one or more indicia, if desired, designating the particular liquid therein and the position of the throttle means structure and/or on/off valve. The dosing dispenser can be in the form of a bottle with an integral cap and/or preferably a separate, squeezable container and a separate cap. The dosing dispenser is particularly useful in, but not limited to, dispensing chemicals used to hand pre-treat cloth or clothing in a dry cleaning operation.

### FIELD OF THE INVENTION

The present invention relates to a dosing dispenser and the use of same, the dispenser having an upper portion preferably including a multifunction cap which may be part of an integral container or used with a separate container or bottle. More particularly, the dispenser may comprise a body incorporating a liquid container, which dispenser can be used, for example, to spot pre-treat clothing manually prior to dry cleaning with a cap thereon, the dispenser dosing applications of the liquid therethrough in a controlled and/or multiple fashion, and providing not only closure to prevent leakage of fluid therefrom but also substantially reducing, if not altogether eliminating, the escape or evaporation of liquid vapors therefrom. If desired, multiple indicia may also be provided on the dispenser to the dispensing rate and/or to indicate the particular liquid therein. The first indicia may be positional and the second indicia in the form of color coding, indicating liquid being dispensed.

### PRIOR ART

Heretofore, numerous dosing dispensers have been proposed.

However, none have been found to provide the combined effects produced by the structure of the herein proposed dosing dispenser.

### SUMMARY OF THE INVENTION

According to the invention there is provided a dosing dispenser for use in dispensing manually a controlled or desired dose of liquid. The dispenser may comprise a liquid containing body, a fill inlet opening into the body for filling the dosing dispenser with liquid, a liquid discharge opening in the body and a liquid discharge path within the body in communication with the discharge opening. The dispenser may have an integral liquid container portion and an upper dispenser, or the dispenser may be in the form of a separate cap cooperating with an associated container. The dispenser's upper portion or cap is provided with a discharge path from the container's portion, through the upper portions and/or cap. The dispenser in another form may include a throttling means, presumably in the form of a manually operated valve to control the rate of dispensing anywhere in between from zero to a maximum. A check valve is located in the discharge path which is operational to permit flow through discharge path to the discharge opening when in a first position, and to prevent flow to the discharge opening when in a second position, whereby the volatile liquid can be dispensed when the check valve is in the first position, but not when in the second position, the liquid being conserved and discharge or evaporation of volatile vapors from the liquid being substantially eliminated when the check valve is in the second position thereof.

Further according to the invention, the dosing dispenser may as noted above include a cap for a body that is being used in dispensing manually a volatile liquid, the cap being engageable with the body to form a container. A liquid discharge opening is provided in the cap, a discharge path in the body terminating at the discharge opening, a check valve operating on the discharge path to permit flow through the discharge path to the discharge opening when in one position and to prevent flow through the discharge path when in a second position thereby conserving volatile liquid and minimizing discharge of vapors from the volatile liquid. The throttle means and/or dispensing valve can be provided on or in the cap.

The dosing dispenser may be used for dispensing volatile dry cleaning chemicals used to manually pre-treat cloths or clothing to be dry cleaned after the manual pre-treatment. As noted above, the dispenser/cap can be given indicia to indicate the type of chemical therein. For example, different color drip or spill sponges or traps may be fitted to the dispenser/cap to so indicate a different chemical. The liquid can be dispensed from the container by means such as shaking, squeezing or both.

### BRIEF DESCRIPTION OF THE DRAWINGS

FIG. 1 is a front elevational view of the dosing dispenser of the present invention, showing it at rest in an upright position.

FIG. 2 is a partially cutaway view into the dispenser, taken along line 2-2 of FIG. 1, showing the check valve and one drip sponge or spillage trap.

FIG. 3 is similar to FIG. 2, but shows an alternative embodiment with multiple spillage traps.

FIG. 4A is an exploded perspective view of the upper portion of the dosing dispenser, including the cap, and shows sponges of two spillage traps having first color indicia.

FIG. 4B shows a second set of sponges having second color indicia.

FIG. 5 is a cross sectional view through the cap of the dosing dispenser showing the same in an upright “closed” position thereof.

FIG. 6 is similar to FIG. 5 but shows the cap in an inverted “open” position thereof.

FIG. 7A is an exploded perspective view of the upper portion of a further embodiment of the dosing dispenser, and show sponges of two spillage traps having first color indicia.

FIG. 7B shows a second set of sponges for the embodiment of FIG. 7A having second color indicia.

FIG. 8 is a cross sectional view through the cap of the dosing dispenser showing same in an upright “closed” position thereof.

FIG. 9 is similar to FIG. 5 but shows the cap in an inverted “open” position thereof.

FIG. 10 is an enlarged, partial cross sectional view through the throttling means or structure of the embodiment of FIG. 7A view same from one circumferential point therealong.

FIG. 11 is a cross sectional view similar to FIG. 10 but viewed from an opposite circumferential point therealong.

### DESCRIPTION OF THE PREFERRED EMBODIMENTS

Referring now to the drawings in greater detail there is illustrated therein in this instance a preferred form of a dosing dispenser 10 having a separate container 14 and a separate cap 16 made in accordance with the teachings of the present invention. As previously noted, the cap and container could have alternatively been made integral. Also the container could be of rigid construction, but preferably is of squeezable construction to permit it be squeezed to permit or cause discharge of fluid or liquid therefrom.

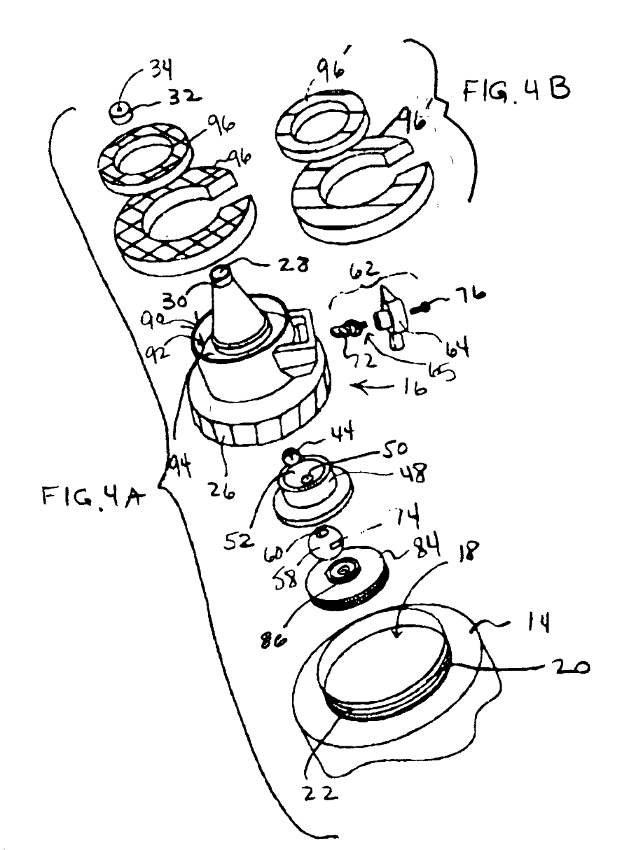

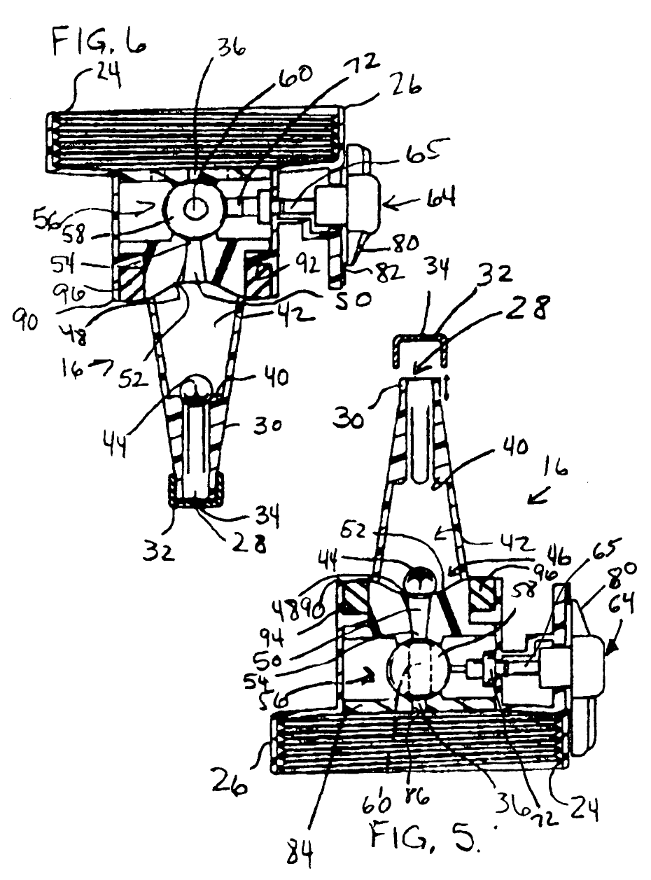

Primarily, the dosing dispenser 10 comprises a body 12 formed, preferably, by a container 14 and a cap 16. The container 14 has a fill inlet or opening 18 (see FIG. 4A) therein, in a neck 20 thereof, which neck 20 has a male threaded outer surface 22. Onto this threaded outer surface 22 of the neck 20 of the container is engaged a female threaded inner surface 24 (FIG. 5) of a base 26 of the cap 16, the thusly engaged container 14 and cap 16 forming the body 12 of the dosing dispenser 10. Of course, the male and female threaded portions could be reversed on the container and cap.

It will be understood, of course, that the exemplary embodiments of the dosing dispenser 10 illustrated and described herein should not be construed as limiting to the scope of the invention, but merely serves to present representative embodiments.

For example, in this respect, the container 14 and cap 16 could just as easily be otherwise joined together, such as, in a snap fit, or other, manner which also will not allow for any leakage therepast. Also as noted above, the container 14 and cap 16 could be integrally formed as one piece.

Once a desired liquid (not shown) is placed within the container 14, via the fill inlet 18, and the cap 16 is engaged onto the container 14, the body 12 of the dosing dispenser 10 is created.

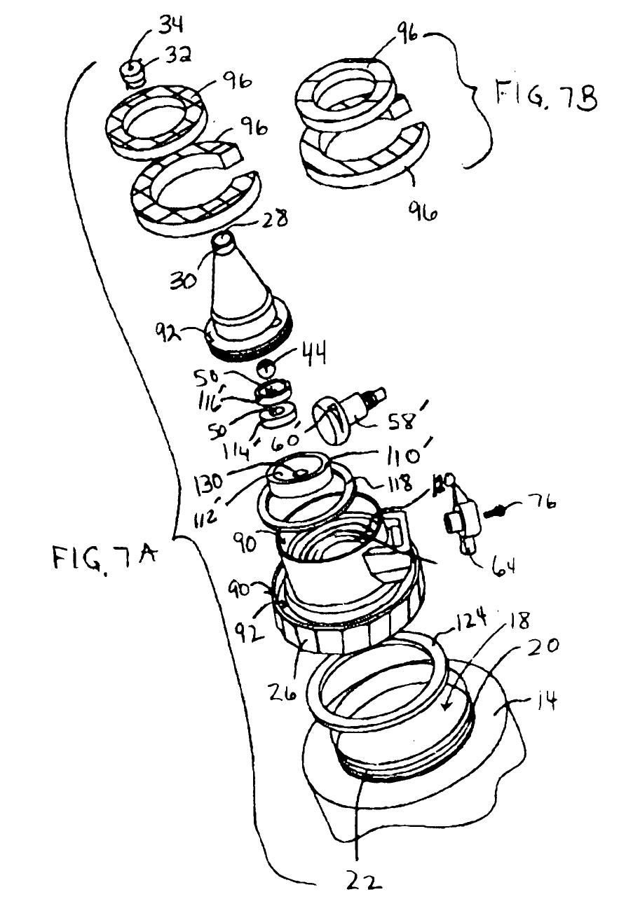

It will be seen that once the liquid is placed into the body 12, in this particular embodiment, only one point of operational egress is available. Such point of egress is in the form of an outlet 28 (FIG. 5) provided in a tip 30 of the cap 16. Positionable over this outlet 28 is a replaceable cover or discharge tip 32. The tip 32 could be made of metal, such as stainless steel, having an outlet port 34 of predetermined size therein, which outlet port 34 forms a decreased in diameter restriction for the outlet 28. The cover or discharge tip 32 may be retained on the cap 16 by press fit or other means. The cover 32 may be selected to determine a desired flow, or replaced should it wear or be damaged, such as by dropping of the dispenser 10. The tip can also be made of a cylinder of teflon with a reduced diameter lower portion with a discharge path therethrough, and say, a press fit of the lower portion into the outlet 28. Such construction is shown in FIG. 7A.

It will be understood of course that an outlet path 36 must be provided in the dosing dispenser 10 so that fluid can pass from the interior of the body 12, and in this instance, to and out of the outlet port 34, for dispensing thereof.

As is apparent from FIG. 4A, the fill inlet or opening 18 into the container 14 also serves to allow for flow of liquid from the container 14, into and through the cap 16, toward the point of egress.

Thus, the fluid path 36 extends through the dispenser 10, beginning in the container 14 and continues through the cap 16, to the outlet port 34, as will now be described in greater detail.

Examining the body 10 more closely, and most particularly the cap 16 thereof, it will first be seen that the cap 16 has a hollow conical tip 30 extending upwardly from the base 26, when the dispenser 10 is viewed in an upright position thereof.

The conical tip 30 decreases in diameter toward the outlet 28, with a portion of the tip 30 adjacent the outlet 28 being provided with a plurality of radially inwardly directed flanges 40 (FIG. 5) therein.

The lower area 42 of the tip 30 is hollow, and has a ball 44 of a check valve 46 therein, which ball 44 bears against the flanges 40 when the dispenser 10 is inverted (FIG. 6) and bears against a seat 48 therefore in the lower area 42 of the tip 30 when the dispenser 10 is righted (as shown in FIGS. 1 and 5).

The valve seat 48 is seen to surround a flowthrough port 50 extending through the material of the seat 48, with an upper surface 52 of the seat 48 being radially inwardly downwardly angled (as shown in FIG. 5) to assure that the ball 44 seats over and seals the flowthrough port 50 by seating directly thereupon, with the ball 44 being sized to be larger than the flowthrough port 50. Such sealing of flowthrough port 50 when the dispenser 10 is in the upright (closed) position acts to keep substantially all liquid vapors from unnecessarily escaping or evaporating from the dispenser 10 when in the upright position.

Adjacent the flowthrough port 50 at end 54 thereof opposite the end on which the ball 44 seats is provided a throttling means or structure 56 which, in this instance, comprises a spherical throttling element 58 having a diametric bore 60 therethrough. This throttle means 56 is used to control the flow of dispensed fluid from the dispenser. Preferably, the throttle means function as an on-off valve and can control flow form zero to a maximum.

This spherical throttling means or element 58 engages an actuator 62 (FIG. 4) which acts to rotate the spherical throttling means or element 58 from a first position where the diametric bore 60 (FIG. 5) therein is in full alignment with the flow through port 50, producing a maximum flow through flow path 36, through to a position where there is no alignment between the bore 60 and flow through port 50, providing zero or no flow through flow path 36.

Obviously, levels of flow between zero (closed) and maximum (fully open) can be obtained by relative positioning between the bore 60 and flow through port 50.

To provide a visual indication of the flow level through the throttling structure 56, a manipulatable lever 64 is provided, which engages a pin 65 which in turn engages the spherical throttling element 58, via a flange 72 on the pin 65 which engages in a slot 74 (FIG. 4A) in the spherical throttling element 58, the slot 74, in this instance, being perpendicular to the diametric bore 60 in spherical structure 58.

Since the pin 65 is fixed to the lever 64, by a suitable connector 76, it rotates with the lever 64.

The lever 64 includes indicia means in the form of a pointer 80 which is associated with positioning indicia 82 (FIG. 1) which indicates the degree of alignment between the bore 60 and flow through port 50, from extremes of fully unaligned (zero flow or closed) to fully aligned (maximum flow or fully open) and, of course, various degrees therebetween, creating a dispenser 10 where dosing is controllable.

It will also be understood that the throttling structure 56, thus, can not only be construed as merely used for throttling flow, but also serves as an on/off valve 56 for the dosing dispenser.

It is of course also desired to bias the spherical throttling element 58 against movement away from its position contiguous to the flow through port 50, to help serve its proposed function. To accomplish this goal, a disk 84 (FIGS. 4A or 5) creating a seat 85 is provided which is conformed to maintain the spherical throttling element 58 adjacent the flow through port 50, and also to extend across the interior of the cap 16. Thus, liquid flow passes through the required flow path 36 formed as described above.

In a preferred embodiment, the disk 84 engages within the cap 16 in a snap fit manner, though other forms of engagement could equally well apply.

Finally, in order for liquid to pass through the disk 84 from the container 14, a bore 86 is provided therein through which liquid from the container 14 can be passed into the bore 60 of the spherical throttling element 58.

It has also been found preferable to keep any spillage from the discharge port 34 from coming into contact with the hand of a user of the dispenser 10. To this end, at least one spillage well or trap 90 is provided between the tip 30 and base 26 of the cap 16. In the preferred embodiment, the spillage trap 90 comprises a recess 92 within which a flat 94 is defined. Seated within the recess 92, upon the flat 94, is a liquid absorbing structure, such as a sponge 96 to trap any potential spillage droplets.

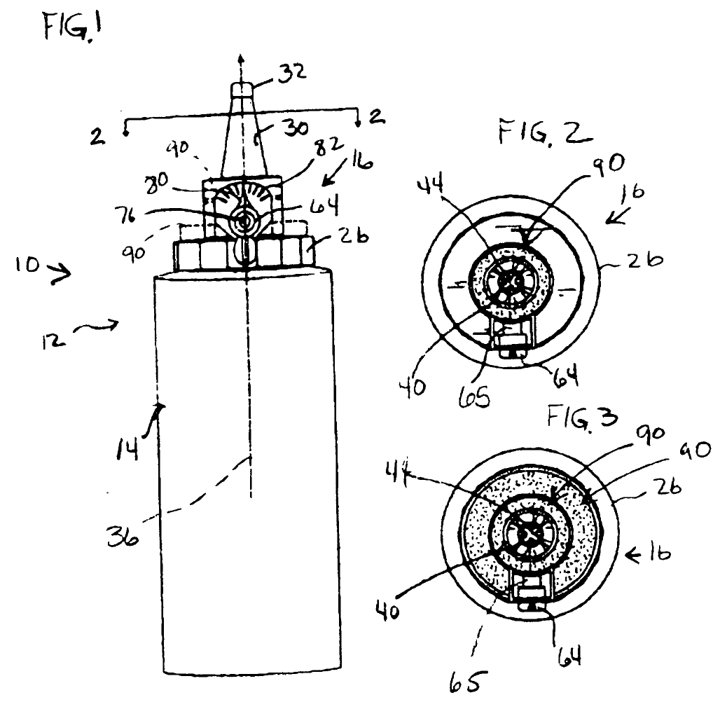

In one embodiment, as illustrated in FIG. 2, one spillage trap 90 is provided, while in another embodiment shown in FIG. 3, plural stacked concentric spillage traps 90, here two, are shown.

In FIG. 4A, one pair of sponges 96 are illustrated which are striated to show the sponges 96 to be orange, indicative of a particular liquid within the dispenser 10.

Conversely, FIG. 4B shows a pair of sponges 96′, striated to show the sponges 96′ to be blue in color, which, where used in another dispenser 10, will provide an indication of another particular liquid being in the dispenser 10. Alternatively, the dispenser 10, bottle 12 or cap 16 or portions thereof could be color coded. For example, the dispenser 10 could be used to dispense dry cleaning liquids or pretreatments of “Tennin Formula” say with a color red, “Protein Formula” with a color blue, P.O.G. (Point, Oil Grease Formula”) with a color green, “Ammonia Formula” with a color yellow, etc. or other colors, for other cleaning formulas or pretreatment, such Hydrogen Peroxide, Acetic Acid, etc. This way the dry cleaning operator or user can quickly select the appropriate treatment chemical, economically use it, limit his/her exposure to vapors (which could be harmful), and greatly reduce loss to spillage and evaporation say by from 20 to 50 percent.

Turning now to FIGS. 7A-11, there is illustrated therein a further embodiment of the dosing dispenser 10. For the sake of brevity, structures generally identical to those of the first embodiment will be identically numbered, avoiding the need to provide further lengthy description thereof Where there is differences, prime numerals or new reference numbers will be used.

This embodiment of the dosing dispenser 10 also comprises a body 12 formed, preferably, by a container 14 and a cap 16, with the container 14 having a fill inlet or opening 18 in a neck 20 thereof.

It will be understood of course that an outlet path 36 must also be provided in this embodiment of the dosing dispenser 10 so that fluid can pass from the interior of the body 12, to and out of the outlet port 34, for dispensing thereof.

The fluid path 36 extends through the dispenser 10, beginning in the container 14 and continues through the cap 16, to the outlet port 34, as will now be described in greater detail.

The cap 16 again has a hollow conical tip 30 extending upwardly from the base 26, and decreasing in diameter toward the outlet 28, with a portion of the tip 30 adjacent the outlet 28 being provided with a plurality of radially inwardly directed flanges 40 therein. The lower area 42 of the tip 30 is hollow, and again incorporates a check valve 46. In this embodiment of the dosing dispenser 10, a throttling structure 56 is also provided.

Here, however, the throttling structure is a cylindrically shaped throttling element 58′ rather than being spherical. This throttling element 58′ engages the actuator 62 (FIG. 8) which rotates the throttling element 58′ from a first position producing a maximum flow through flow path 36, through decreasing levels of flow to a position, providing zero or no flow through flow path 36. A visual indication of the flow level through the throttling structure 56 is again provided by a manipulatable lever 64. Since the throttling element 58′ is fixed to the lever 64, by a suitable connector 76, it rotates with the lever 64 and its associated pointer 80 which is further associated with positioning indicia 82.

This embodiment of the throttling element 58′ provides a throughbore 60′ therein which is comprised of two triangular or arrowhead shaped openings 100 which are diametrically opposed and which converge at a midpoint within a head 102 of the cylindrical shaped throttling element 58′. The openings 100 are oriented such that a tip 104 of each opening is opposite a base 106 of the opposed opening 100. Thus the maximum degree of flow through the throughbore 60′ is achieved when center areas 108 of the openings 100 are aligned with the flowthrough port 50 in the check valve 46, as best illustrated in FIGS. 10 and 11.

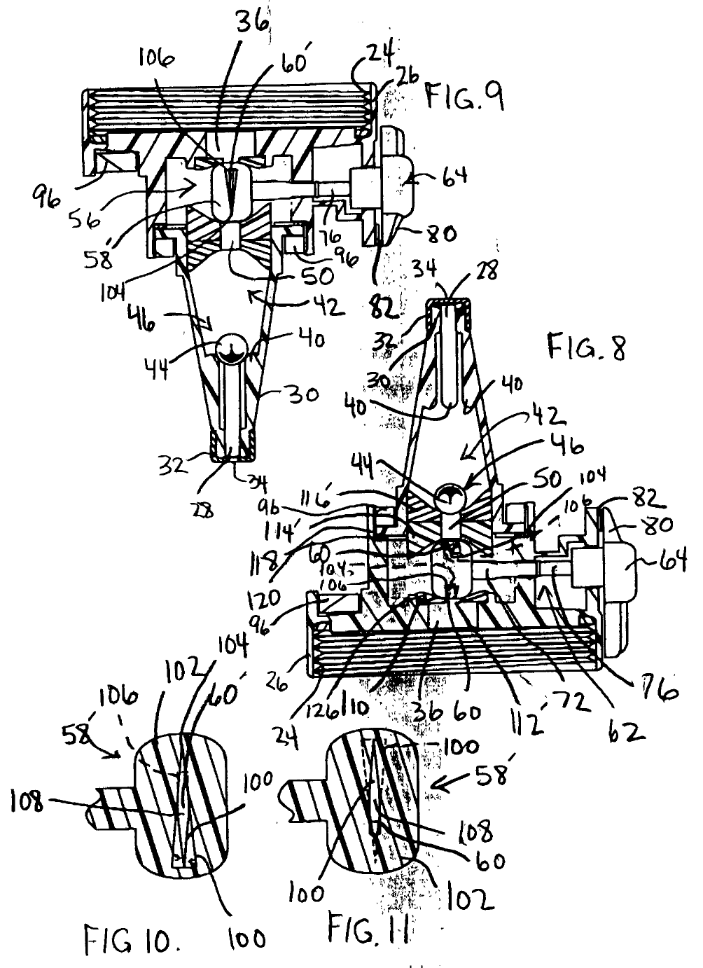

Obviously flowthrough decreases as throttling element 58′ is turned in either direction from the center point, until a position is attained as best shown in FIG. 9, where the throughbore 60′ is completely out of alignment with flowthrough port 50, effectively closing off flowthrough the dosing dispenser 10.

It is of course also desired to bias the mushroom or cylindrically shaped throttling means or element 58′ against movement away from its position contiguous to the flow through port 50, to help serve its proposed function. To accomplish this goal, a disk 110′ creating a seat 112′ is provided which is conformed to maintain the element 58′ adjacent the flowthrough port 50, now extends through two disks 114′ and 116′, the disk 114′ creating a top seat for the element 58′ and the disk 116′ creating the valve seat 48 for the check valve 46, as best illustrated in FIGS. 8 and 9. Thus, liquid flow passes through the required flow path 36 formed as described above.

It will be seen in this embodiment that the cap 16 is formed as a two piece structure, with the tip 30 being engageable to the base 26 in a snap fit or other suitable manner. In this respect, the tip 30 incorporates a bottom flange 92 which forms the flat 94 of the spillage trap 90, the flange 92 seating upon a seal ring 118 positioned over a shoulder 120 of the base 26. A further seal ring 124 may, if desired, be provided for seating between the base 26 of the cap 16 and the neck 20 of the container 14.

Also, in this embodiment the seat 112′ for the throttling element 58′ is also seen to seat upon an internal shoulder 126 which surrounds a portion of the outlet path 36 through the base 26 of the cap 16, the port 130 in the seat 112′ being of smaller diameter than the outlet path 36, and corresponding approximately to a width of the base 106 of the triangular opening 100 in the throttling element 58.

The dispensers 10 can be used in the following manner. A plurality of dispensers 10 could be provided with different color indicia for the various above-mentioned cleaning fluids. If a dispenser has two indica for chemicals they could both be the same color or each a different color. Thus a Red-Red is different from a Red-Blue or even a Blue-Red, giving a large number of variations. The dispensers can be filled with the desired cleaning fluid and the on-off valve/throttle means can be set to permit the desired flow, the indicia facilitating this adjustment. The dispenser or dispensers are placed in the upright position (like that shown in FIG. 1), with the check valve in a closed position to prevent escape of vapor. The dispenser is then picked up by the dry cleaner and generally inverted and shook, to move the check valve off the seat to permit the desired rate of flow onto the spot or clothing or cloth to be pretreated before being dry cleaned. These dispensers could be used with a spotting gun and spot cleaning table like that described in my copending U.S. application Ser. No. 09/566,362, filed May 8, 2000, now U.S. Pat. No. 6,375,686. After use, the dispenser can be set down and the check valve then closes to prevent escape of vapor, saving fluids and reducing exposure to vapors. If the dispenser is not likely to be used for awhile, the on-off valve/throttle means could be closed, which would also prevent spillage should the dispenser be unintentionally overturned.

Thus, it will be understood that the dispenser 10 provides a number of advantages, as does the cap 16 thereof, some of the advantages being described above and others of which are inherent in the invention.

Also modifications may be made including equivalent elements and/or steps without departing from the teachings herein. Accordingly, the scope of the invention is only to be limited as necessitated by the accompanying claims and their equivalents.

What is claimed is:

1. A dosing dispenser for use in dispensing manually a desired dose of liquid, the dispenser comprising a body adapted to contain a liquid, a fill inlet opening into said body for filling said dosing dispenser with liquid, a liquid discharge opening in said body, a liquid discharge path within said body in communication with said discharge opening, a check valve in said discharge path which is operational to permit flow through discharge path to said discharge opening when in a first position, and to prevent flow to said discharge opening when in a second position, whereby said liquid can be dispensed when said check valve is in said first position, but not when in said second position, said liquid being conserved and discharge of vapors from said liquid being substantially eliminated when said check valve is in said second position thereof.

2. A dosing dispenser as in claim 1, further comprising an on-off valve, said on-off valve being manually settable to prevent discharge of said liquid should said check valve be placed in any position.

3. A dosing dispenser in claim 1, further comprising means for throttling the flow of liquid from said container at a desired rate, said throttle means being manually adjustable to vary rate of liquid flow through said discharge path.

4. A dosing dispenser as in claim 3, wherein said throttle means can be adjusted between about zero and maximum flow.

5. A dosing dispenser as in claim 2, wherein said on-off valve includes said throttle means for throttling the flow in the discharge path from about zero flow to maximum flow.

6. A dosing dispenser as in claim 1, wherein a discharge tip is engaged over the discharge opening.

7. A dosing dispenser as in claim 6, wherein said discharge tip is made of metal.

8. A dosing dispenser as in claim 7, wherein said discharge tip is made of teflon.

9. A dosing dispenser as in claim 1, wherein said container has one or more spillage traps about the discharge opening.

10. A dosing dispenser as in claim 9, wherein said spillage trap, include means for absorbing liquid.

11. A dosing dispenser as in claim 10, wherein said means for absorbing comprise a sponge.

12. A dosing dispenser as in claim 9, wherein said spillage trap is a flat formed about and surrounding the discharge opening, and said sponge sits on said flat.

13. A dosing dispenser as in claim 12, wherein said body is recessed to form said flat and said sponge fits in said recess.

14. A dosing dispenser as in claim 1, wherein a plurality of containers are provided, one for each different particular liquid, and each container incorporates indicia to signify the particular liquid therein.

15. A dosing dispenser as in claim 1, wherein said body further includes a cap.

16. The dosing dispenser as in claim 15, wherein said cap includes therein at least said discharge opening and said check valve.

17. The dosing dispenser as in claim 15, wherein said cap includes throttling means for throttling flow, said discharge opening, and said check valve.

18. The dosing dispenser as in claim 15, wherein said cap includes an on/off valve, said discharge opening, and said check valve.

19. The dosing dispenser as in claim 18, wherein said on/off valve also functions as a means for throttling the flow of said liquid.

20. A cap that is adapted for use with a dosing dispenser body that is used to dispense a liquid, said cap being adapted to be engageable to a container to form said body, a liquid discharge opening in said cap, a discharge path in said body terminating at said discharge opening, a check valve operating on said discharge path to permit flow through said body to said discharge opening when in one position and to prevent flow through said body when in a second position, thereby conserving liquid and minimizing discharge of any vapors from said liquid.

21. A cap as in claim 20, further comprising an on-off valve, said on-off valve being manually settable to prevent discharge of said liquid.

22. A cap as in claim 20, further comprising throttle means on said cap for throttling the flow of the liquid through said cap at a desired rate, said throttle means being manually adjustable to throttle the rate of liquid and flow through said cap.

23. A cap as in claim 21, wherein said throttle means can be adjusted between zero and maximum flow.

24. A cap as in claim 20, wherein said on-off valve also functions as said throttle means to throttle liquid flow in the discharge path from about zero flow to a maximum flow.

25. A cap as in claim 20, wherein said cap has a discharge tip positioned over the discharge opening.

26. A cap as in claim 25, wherein said discharge tip is made of one of metal or teflon.

27. A cap as in claim 18, wherein said cap has one or more spillage traps.

28. A cap as in claim 27, wherein said spillage traps include means for absorbing spills.

29. A cap as in claim 28, wherein said means for absorbing spills comprise a sponge.

30. A cap as in claim 27, wherein said spillage traps are one or more flats formed about and surrounding the discharge opening, and includes one or more sponges conforming to said at least one or more flats.

31. A cap as in claim 30, wherein said cap is recessed to form a recess about said one or more flats and said sponge fits in said recess.

32. A cap as in claim 18, wherein a plurality of caps are provided, one for each particular liquid to be dispensed, and each cap incorporates indicia to signify a particular liquid.

33. A cap as in claim 32, wherein the indicia is in the form of color coding.

34. A cap is in claim 32, wherein said cap includes spillage traps including one or more sponges, said one or more sponges being color coded.

35. A method for spot pre-treating clothing prior to dry cleaning using a pre-treating chemical dispenser for dispensing dry cleaning chemical, comprising the steps of opening the dispenser for flow of the chemical, setting the rate of flow of chemical from the dispenser to a desired rate, flowing the chemical through a check valve, permitting flow of chemical from the dispenser through the check valve only when both the dispenser and check valve are in an open position, whereby clothing can be spot pre-treated, but the rate of flow controlled and the emission of vapors prevented.

36. A method as in claim 35, wherein a plurality of dispensers is provided, each dispenser containing a different dry cleaning chemical providing each of the plurality of dispensers with different indicia to indicate its contents, selecting the appropriate dispenser or dispensers to pre-treat a spot on the clothing.

37. A method as in claim 35, wherein the step of flowing includes the step of one of shaking or squeezing the dispenser to cause flow.

38. A method as in claim 37, wherein the step of flowing includes the step of both shaking and squeezing the dispenser to cause flow.
